(19) United States
(12) Patent Application Publication
(10) Pub. No.: US 2024/0110497 A1
(43) Pub. Date: Apr. 4, 2024

(54) PLANETARY GEAR SYSTEM ARRANGEMENT WITH AUXILIARY OIL SYSTEM

(71) Applicant: RTX CORPORATION, Farmington, CT (US)

(72) Inventors: William G. Sheridan, Southington, CT (US); Michael E. McCune, Colchester, CT (US); Lawrence E. Portlock, Bethany, CT (US)

(21) Appl. No.: 18/536,711

(22) Filed: Dec. 12, 2023

Related U.S. Application Data
(63) Continuation of application No. 16/006,327, filed on Jun. 12, 2018, now Pat. No. 11,885,252.
Application No. 16/006,327 is a continuation of application No. 15/621,406, filed on Jun. 13, 2017, now Pat. No. 10,648,383.
Application No. 15/621,406 is a division of application No. 14/474,869, filed on Sep. 2, 2014, now Pat. No. 9,677,420.
Application No. 14/474,869 is a division of application No. 14/266,888, filed on May 1, 2014, now Pat. No. 8,931,285.
Application No. 14/266,888 is a continuation of application No. 13/428,491, filed on Mar. 23, 2012, now Pat. No. 9,995,174.
Application No. 13/428,491 is a continuation-in-part of application No. 12/902,525, filed on Oct. 12, 2010, now Pat. No. 8,813,469.
Application No. 16/006,327 is a continuation of application No. 13/428,491, filed on Mar. 23, 2012, now Pat. No. 9,995,174.

(51) Int. Cl. F01N 3/20; F01D 25/16; F01D 25/18; F01N 11/00; F02C 3/10; F02C 7/06; F02C 7/10; F02C 7/36; F02K 3/06

(52) U.S. Cl. CPC F01N 3/208; F01D 25/16; F01D 25/18; F01N 3/2066; F01N 11/00; F02C 3/10; F02C 7/06; F02C 7/10; F02C 7/36; F02K 3/06; F05D 2260/40311; F16N 7/34; Y10T 29/4932

(57) ABSTRACT

A gas turbine engine includes a fan shaft diving a fan having fan blades. The gas turbine engine also includes a gear system including a sun gear surrounded by a plurality of intermediate gear, a carrier at least partially supporting said plurality of intermediate gears, and a ring gear surrounding said plurality of intermediate gears, wherein said sun gear is driven by a turbine. The gas turbine engine also includes a flexible coupling fixing said ring gear from rotation relative to an engine static structure and a lubricating system for said gear system. Said lubricating system includes a lubricant input, there being a stationary first bearing receiving lubricant from said lubricant input. Said bearing has an inner first race in which lubricant flows, and a second bearing for rotation within said first bearing. Said second bearing has a first opening in registration with said inner first race such that lubricant may flow from said inner first race through said first opening into a first conduit. Said first conduit is in fluid communication with said plurality of intermediate gears. A gas turbine engine is also disclosed.

This application is a continuation of U.S. Ser. No. 16/006,327, filed Jun. 12, 2018, which is a continuation of U.S. Ser. No. 13/428,491, filed Mar. 23, 2012, which is now U.S. Pat. No. 9,995,174 granted Jun. 12, 2018, which is a continuation-in-part application of U.S. Ser. No. 12/902,525, filed Oct. 12, 2010, which is now U.S. Pat. No. 8,813,469 granted Aug. 26, 2014. U.S. Ser. No. 16/006,327 is also a continuation of U.S. Ser. No. 15/621,406, filed Jun. 13, 2017, which is a divisional of U.S. Ser. No. 14/474,869, filed Sep. 2, 2014, which is now U.S. Pat. No. 9,677,420 granted Jun. 13, 2017, which is a divisional of U.S. Ser. No. 14/266,888, filed May 1, 2014, which is now U.S. Pat. No. 8,931,285 granted Jan. 13, 2015, which is a continuation of U.S. Ser. No. 13/428,491, filed Mar. 23, 2012, which is now U.S. Pat. No. 9,995,174 granted Jun. 12, 2018, which is a continuation-in-part application of U.S. Ser. No. 12/902,525, filed Oct. 12, 2010, which is now U.S. Pat. No. 8,813,469 granted Aug. 26, 2014.

### FIELD

This invention relates to planetary gear trains and more particularly to a lubricating system for a planetary gear train.

### BACKGROUND

Planetary gear trains are complex mechanisms that reduce, or occasionally increase, the rotational speed between two rotating shafts or rotors. The compactness of planetary gear trains makes them appealing for use in aircraft engines where space is at a premium.

The forces and torque transferred through a planetary gear train place stresses on the gear train components that may make them susceptible to breakage and wear. In practice, conditions may be less than ideal and place additional stresses on the gear components. For example the longitudinal axes of a planetary gear train's sun gear, planet carrier, and ring gear are ideally coaxial with the longitudinal axis of an external shaft that rotates the sun gear. Such perfect coaxial alignment, however, is rare due to numerous factors including imbalances in rotating hardware, manufacturing imperfections, and transient flexure of shafts and support frames due to aircraft maneuvers. The resulting parallel and angular misalignments impose moments and forces on the gear teeth, the bearings which support the planet gears in their carrier, and the carrier itself. These imposed forces and moments may cause gear component wear and increase a likelihood that a component may break in service. Component breakage is undesirable in any application, but particularly so in an aircraft engine. Moreover, component wear necessitates inspections and part replacements which may render the engine and aircraft uneconomical to operate.

The risk of component breakage may be reduced by making the gear train components larger and therefore stronger. Increased size may also reduce wear by distributing the transmitted forces over correspondingly larger surfaces. However increased size offsets the compactness that makes planetary gear trains appealing for use in aircraft engines, and the corresponding weight increase is similarly undesirable. The use of high strength materials and wear resistant coatings can also be beneficial, but escalates the cost of the gear train and therefore does not diminish the desire to reduce wear.

Stresses due to misalignments can also be reduced by the use of flexible couplings to connect the gear train to external devices such as rotating shafts or non-rotating supports. For example, a flexible coupling connecting a sun gear to a drive shaft flexes so that the sun gear remains near its ideal orientation with respect to the mating planet gears even though the axis of the shaft is oblique or displaced with respect to a perfectly aligned orientation. Many prior art couplings, however, contain multiple parts that require lubrication and are themselves susceptible to wear. Prior art couplings may also lack adequate rigidity and strength, with respect to torsion about a longitudinal axis, to be useful in high torque applications.

### SUMMARY

A gas turbine engine according to an exemplary embodiment of this disclosure, among other possible things include a fan shaft diving a fan having fan blades. The gas turbine engine also includes a gear system including a sun gear surrounded by a plurality of intermediate gear, a carrier at least partially supporting said plurality of intermediate gears, and a ring gear surrounding said plurality of intermediate gears. Said sun gear is driven by a turbine. The gas turbine engine also includes a flexible coupling fixing said ring gear from rotation relative to an engine static structure and a lubricating system for said gear system. Said lubricating system includes a lubricant input and a stationary first bearing receiving lubricant from said lubricant input. Said bearing has an inner first race in which lubricant flows, and a second bearing for rotation within said first bearing. Said second bearing has a first opening in registration with said inner first race such that lubricant may flow from said inner first race through said first opening into a first conduit. Said first conduit is in fluid communication with said plurality of intermediate gears.

In a further example of the foregoing, said ring gear includes a recess located radially outward of gear teeth on said ring gear.

In a further example of any of the foregoing, said ring gear includes a radially extending fluid passage for directing lubricant from said first conduit to said flexible coupling.

In a further example of any of the foregoing, said ring gear comprises a first gear portion with a first set of teeth and a second gear portion with a second set of teeth. Said recess is configured to balance force transmitted through said ring gear and said recess comprises a first half-recess in said first gear portion and a second half-recess in said second gear portion.

In a further example of any of the foregoing, the gas turbine engine also includes a forward gutter and an aft gutter around an outer edge of said ring gear to collect lubrication used by said lubrication system.

In a further example of any of the foregoing, said aft gutter is spaced radially from said forward gutter.

In a further example of any of the foregoing, said aft gutter is in fluid communication with said forward gutter through an axially extending passage in said ring gear.

In a further example of any of the foregoing, said first bearing further comprises a stationary second race into which lubricant flows. Said second bearing has a second opening in registration with said second race such that lubricant flows from said second race through said second opening into a second conduit.

In a further example of any of the foregoing, said second conduit passes lubricant to a component of said gas turbine engine.

In a further example of any of the foregoing, said first conduit passes lubricant to a first part of said gas turbine engine and said second conduit passes lubricant to a second part of said gas turbine engine different from said first part of said gas turbine engine.

In a further example of any of the foregoing, said second conduit passes lubricant to a spray bar. Said spray bar is disposed on said carrier and provides lubricant to said plurality of intermediate gears and to said ring gear.

In a further example of any of the foregoing, said first bearing had a third inner race and said second bearing has a third opening in registration with said third inner race and a third conduit for passing lubricant through said first spray bar.

In a further example of any of the foregoing, the gas turbine engine also includes a second spray bar extending from said first spray bar.

In a further example of any of the foregoing, said second spray bar provides lubricant to a low spool of said gas turbine engine.

In a further example of any of the foregoing, said ring gear comprises a recess, and a first gear portion with a first set of teeth, and a second gear portion with a second set of teeth. Said recess comprises a first half-recess radially outward of gear teeth in said first gear portion and a second half-recess radially outward of gear teeth in said second gear portion.

A gas turbine engine according to an exemplary embodiment of this disclosure, among other possible things include a fan shaft diving a fan having fan blades. The gas turbine engine also includes a gear system including a sun gear surrounded by a plurality of intermediate gear, a carrier at least partially supporting said plurality of intermediate gears, and a ring gear surrounding said plurality of intermediate gears. Said sun gear is driven by a turbine. The gas turbine engine also includes a planetary gear train having at least one planetary gear, a sun gear, a ring gear fixed from rotation relative to an engine static structure, a carrier supporting said at least one planetary gear, said carrier driving said fan. The gas turbine engine also includes a flexible coupling fixing said ring gear from rotation relative to an engine static structure. The gas turbine engine also includes lubricating system for said planetary gear train, said lubricating system including a stationary oil transfer bearing configured to receive lubrication for said lubricating system, and at least one gutter around an outer edge of said ring gear to collect lubrication used by said lubrication system. The gas turbine engine also includes a low spool for driving said fan via said planetary gear train.

In a further example of the foregoing, said at least one gutter includes a forward gutter and an aft gutter located around an outer edge of said ring gear to collect lubrication used by said lubrication system.

In a further example of any of the foregoing, said aft gutter is spaced radially from said forward gutter.

In a further example of any of the foregoing, said aft gutter is in fluid communication with said forward gutter through an axially extending passage in said ring gear.

In a further example of any of the foregoing, said stationary oil transfer bearing is a first bearing and further comprising a second bearing projecting aft from said carrier about said low spool. Said stationary oil transfer bearing is prevented from rotation by attachment to said at least one gutter.

In a further example of any of the foregoing, said first bearing has an inner first race in which lubricant flows, and said second bearing is configured for rotation within said first bearing. Said second bearing has a first opening in registration with said inner first race such that lubricant may flow from said inner first race through said first opening into a first conduit.

In a further example of any of the foregoing, said stationary oil transfer bearing is attached to said at least one gutter via a link Said link is attached to an oil input coupling via a tab. Said oil input coupling is attached to said at least one gutter.

In a further example of any of the foregoing, said tab includes ears extending from said tab, and said link is attached to said ears via a pin.

In a further example of any of the foregoing, said stationary oil transfer bearing includes a boss, said boss including a pair of ears. Said link is attached to said boss via a ball and a pin extending through said ball and said pair of ears.

In a further example of any of the foregoing, said ball allows said oil transfer bearing to flex or torque with said low spool.

In a further example of any of the foregoing, said first bearing also has a stationary second race into which lubricant flows, and said second bearing having a second opening in registration with said second race such that lubricant flows from said second race through said second opening into a second conduit.

In a further example of any of the foregoing, said first conduit passes lubricant to a first part of said gas turbine engine, and said second conduit passes lubricant to a second part of said gas turbine engine different from said first part of said gas turbine engine.

In a further example of any of the foregoing, the gas turbine engine also includes a spray bar disposed on said carrier receiving lubricant from said second conduit and providing lubricant to said at least one planetary gear and to said ring gear.

In a further example of any of the foregoing, the gas turbine engine also includes a second spray bar extending from said first spray bar.

In a further example of any of the foregoing, said second spray provides lubricant to said low spool and lubricant flows from said first spray bar to said second spray bar.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 is a schematic view, partially in section, of a gas turbine engine.

FIG. 2 is a sectional view taken along the lines 2-2 in FIG. 1.

FIG. 2A is a sectional view through the gear drive.

FIG. 3 is a sectional view taken along the lines 3-3.

FIG. 3A is a sectional view taken along the line A-A of FIG. 3.

FIG. 3B is a sectional view taken along the line B-B of FIG. 3.

FIG. 3C is a sectional view taken along the line C-C FIG. 3.

FIG. 4 is a sectional view of a portion of oil flow path A.

FIG. 5 is a sectional view of an upper portion of the planetary gear system of FIG. 1.

FIG. 6 is a sectional view of a lower portion of the planetary gear system of FIG. 1.

FIG. 7 is a sectional view of a flow of oil into gutters.

### DETAILED DESCRIPTION

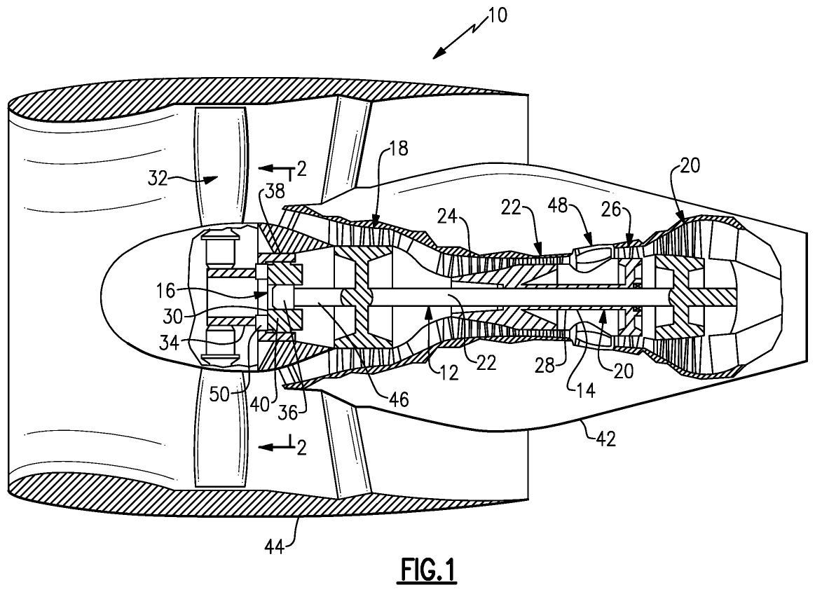

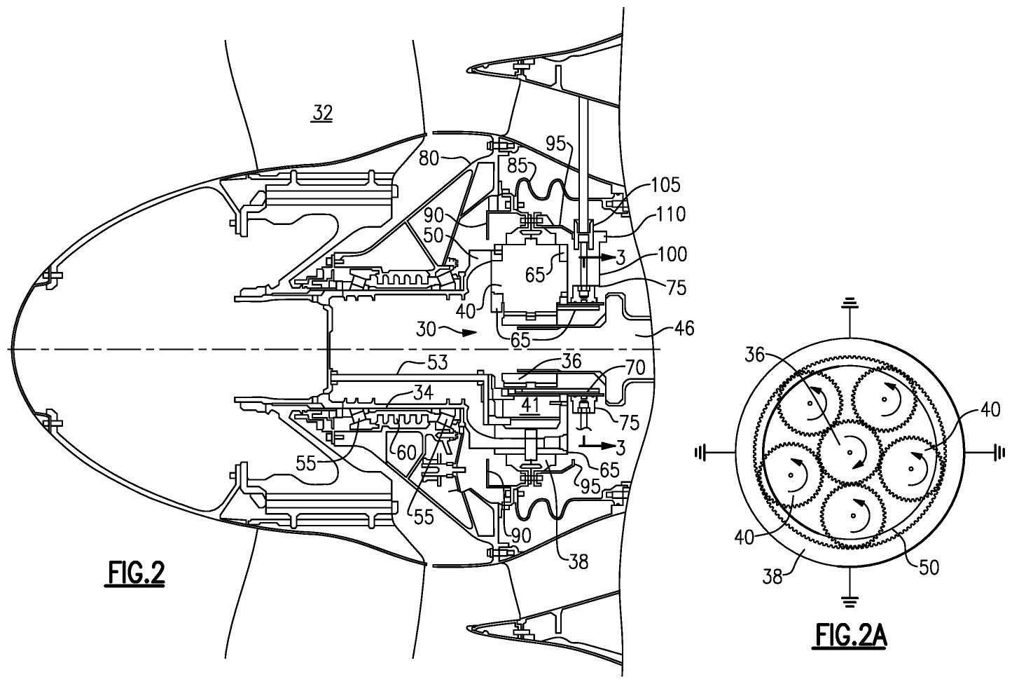

FIG. 1 shows a schematic cross-section of gas turbine engine 10. Gas turbine engine 10 includes low pressure spool 12, high pressure spool 14 and fan drive gear system (“FDGS”) 16. Low pressure spool 12 includes low pressure compressor 18 and low pressure turbine 20, which are connected by low pressure shaft 22. High pressure spool 14 includes high pressure compressor 24 and high pressure turbine 26, which are connected by high pressure shaft 28. Fan drive gear system 16 includes epicyclic gear train 30 that drives a fan assembly 32 by way of a carrier shaft 34. Epicyclic gear train 30 includes sun gear 36, ring gear 38 and planetary gears 40 as will be shown hereinbelow. A carrier 50 is shown schematically in FIG. 4 between shaft 34 and ring gear 38. Details of this connection are better shown in FIG. 2.

Low pressure spool 12 and high pressure spool 14 are covered by engine nacelle 42, and fan assembly 32 and nacelle 42 are covered by fan nacelle 44. Low pressure spool 12, high pressure spool 14 and fan assembly 32 comprise a two-and-a-half spool gas turbine engine in which epicyclic gear train 30 couples fan assembly 32 to low pressure spool 12 with input shaft 46.

Fan assembly 32 generates bypass air for producing thrust that is directed between engine nacelle 42 and fan nacelle 44, and core air that is directed into engine nacelle 42 for sequential compression with low pressure compressor 18 and high pressure compressor 24. Compressed core air is routed to combustor 48 wherein it is mixed with fuel to sustain a combustion process. High energy gases generated in combustor 48 are used to turn high pressure turbine 26 and low pressure turbine 20. High pressure turbine 26 and low pressure turbine 20 rotate high pressure shaft 28 and low pressure shaft 22 to drive high pressure compressor 24 and low pressure compressor 18, respectively. Low pressure shaft 22 also drives input shaft 46, which connects to epicyclic gear train 30 to drive fan assembly 32.

Referring now to FIG. 2 and FIG. 2A, a view of the planetary gear system having exemplary oil supply system is shown. The system is comprised of a input shaft 46, sun gear 36 attaching thereto a plurality of planetary gears 40 that rotate about the sun gear 36, stationary ring gear 38, and a carrier 50 that rotates about the star gear to drive the fan assembly 32. As the ring gear 38 is stationary, the rotation of the sun gear 36 causes each planetary gear 40 to counter-rotate relative to the direction of rotation of the sun gear 36 and simultaneously to orbit the sun gear 36 in the direction of the sun gear's rotation. In other words, whereas each planetary gear 40 individually counter-rotates relative to the sun gear 36, the group of planetary gears 40 co-rotates with the sun gear 36. Moreover, as the carrier 50 is driven by the rotation of the group of planetary gears 40, the carrier 50 also co-rotates with respect to the sun gear 36. Finally, as the fan 32 is driven by the carrier 50 (via shaft 34), the fan 32 also co-rotates with respect to the sun gear 36 and the low spool shaft 46. Thus, in this embodiment, the fan 32 rotates in the same direction as the low pressure compressor 18.

A first spray bar 41 is mounted to the carrier 50 in between each planetary gear 40 that lubricates the planet gears 40 and ring gear 38. A second spray bar 53 is attached to the first spray bar 41 and extends forward to provide lubrication to the carrier shaft 34 that is supported by tapered bearings 55 that are tensioned by spring 60.

The carrier 50 has a shaft 34 for driving the fan assembly 32, a circular body 65 for holding the planetary gears 40 and a cylinder 70 projecting aft about the input shaft 46. The cylinder 70 also closely interacts with a stationary oil transfer bearing 75.

A grounding structure 80 holds the TUGS 16, the ring gear 38, forward gutter 90 and aft gutter 95. The flexible coupling 85 is disposed around the rotary input shaft 46. The forward gutter 90 and an aft gutter 95 attach to and around the outer edge of the ring gear 38 to collect oil used by the system for reuse as will be discussed herein. Oil is input through the stationary oil transfer bearing 75 to the cylinder 70 (e.g. also a bearing) as will be discussed herein.

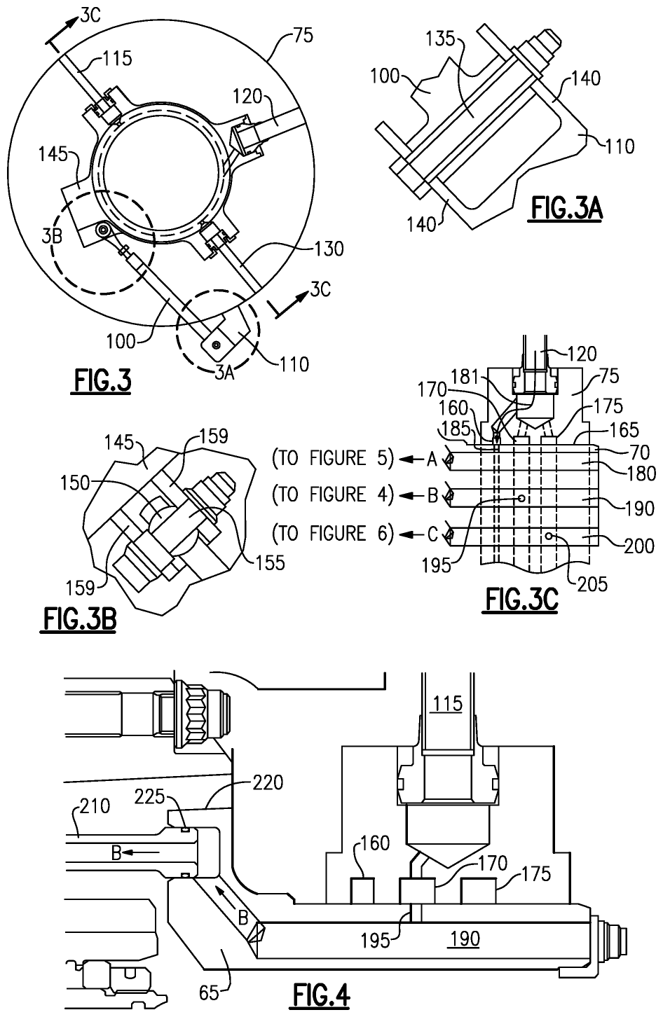

Referring now to FIG. 3, a side, sectional view of the oil transfer bearing 75 is shown. The oil transfer bearing 75 is prevented from rotational movement by attachment of a link 100 via tab 110 to an oil input coupling 105 that attaches to the stationary aft gutter 95 (see also FIG. 2).

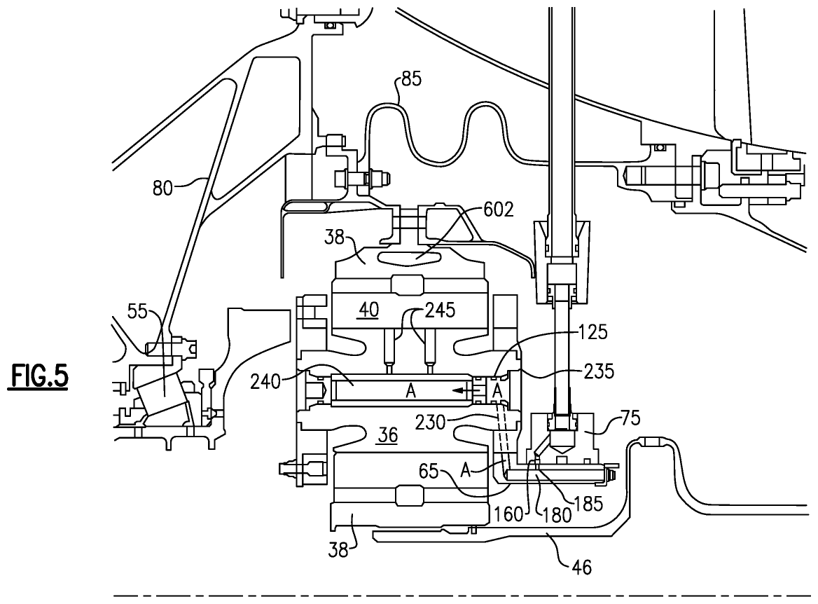

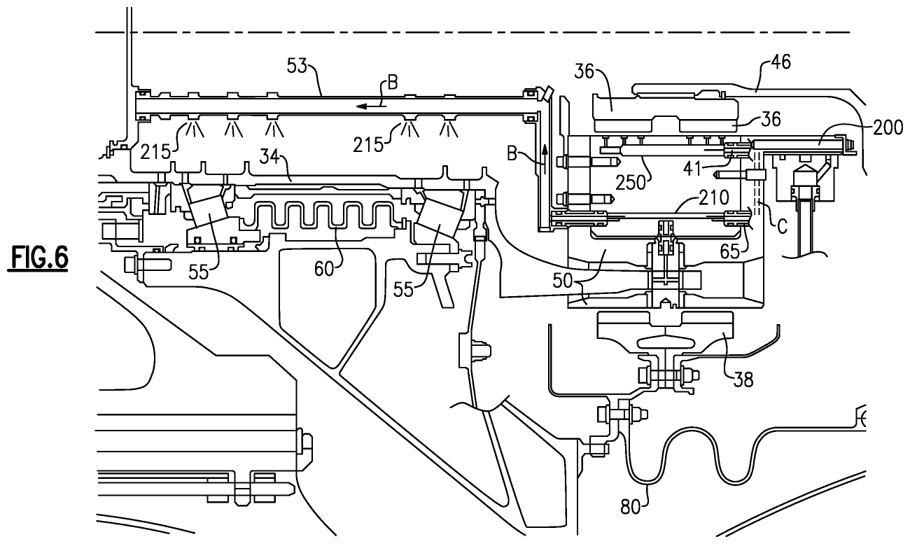

The oil transfer bearing 75 has a plurality of inputs to provide oil to those portions of the FDGS 16 that require lubrication during operation. For instance, oil from tube 115 is intended to lubricate the tapered bearings 55, oil from tube 120 is intended to lubricate the planet gear bearings 125 (see FIG. 5), and oil from tube 130 is intended to lubricate the planet and ring gears, 38, 40. Though three inputs are shown herein, other numbers of oil inputs are contemplated herein.

Referring now to FIGS. 3A and 3B, the link 100 attaches via a pin 135 to the ears 140 extending from the tab 110. The link 100 extends towards a boss 145 on the oil transfer bearing 75 and is attached thereto by a ball 150 and a pin 155 extending through the ball and a pair of ears 159 on the boss 145 on the oil transfer bearing 75. The ball 150 allows the oil transfer bearing 75 to flex with the rotary input shaft 46 as torqueing moments are experienced by the fan assembly 32 and other portions of the engine 10. The link 100 prevents the oil transfer bearing 75 from rotating while allowing it to flex.

Referring now to FIG. 3C, a cross-sectional view of the oil transfer bearing 75 is shown. The oil transfer bearing has a first race 160 that has a rectangular shape and extends around the interior surface 165 of the oil transfer bearing 75, a second race 170 that has a rectangular shape and extends around the interior surface 165 of the oil transfer bearing 75 and a third race 175 that has a rectangular shape and extends around the interior surface 165 of the oil transfer bearing 75. In the embodiment shown, tube 120 inputs oil via conduit 180 into the first race 160.

Cylinder 70 which extends from the carrier circular body 65, has a first oil conduit 180 extending axially therein and communicating with the first race 160 via opening 185, a second oil conduit 190 extending axially therein and communicating with the second race 170 via opening 195 and a third oil conduit 200 extending axially therein and communicating with the third race 175 via opening 205. As the cylinder 70 rotates within the oil transfer bearing 75, the openings 185, 195, 205 are constantly in alignment with races 160, 170, 175 respectively so that oil may flow across a rotating gap between the oil transfer bearing 75 and the cylinder 65 through the openings 185, 195, 205 to the conduits 180, 190, 200 to provide lubrication to the areas necessary in engine 10. As will be discussed herein, oil from conduit 180 flows through pathway A, oil from conduit 190 flows through pathway B and oil from conduit 200 flows through pathway C as will be shown herein.

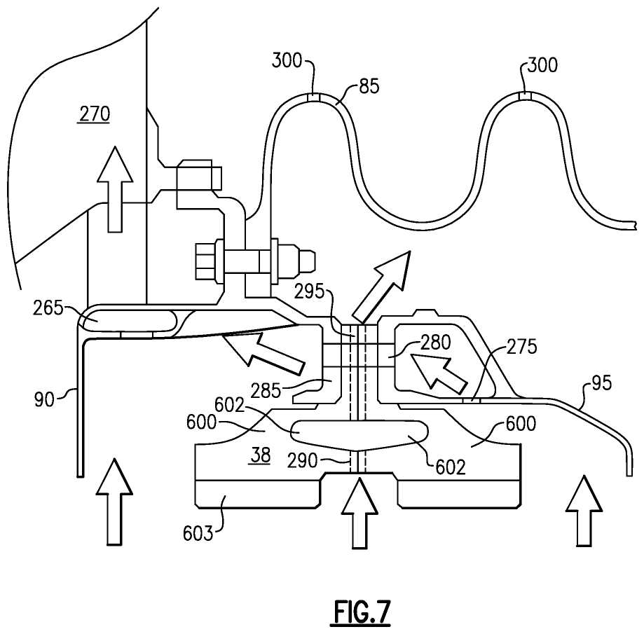

Referring now to FIGS. 4 and 6, oil from the tube 115 flows into second race 170, through opening 195 into conduit 190. From conduit 190, the oil flows through path B into a pipe 210 in the first spray bar 41 to the second spray bar 53 where it is dispersed through nozzles 215. Pipe 210 is mounted into fixtures 220 in the circular body 65 by o-rings 225 the oil FIG. 4, the journal oil bearing input passes through tube, and tube into transfers tubes through tube into the interior of each planetary gear. Each planetary gear has a pair of transverse tubes communicating with the interior of the planetary journal bearing to distribute oil between the planetary gear and the ring gear and a set of gears to provide lubricating area oil to the journal bearings 235 themselves.

Referring now to FIGS. 3C and 5, the flow of oil through path A is shown. The oil leaves conduit 180 through tube 230 and flows around journal bearings 235 that support the planet gear 40 and into the interior of shaft 240. Oil then escapes from the shaft 240 through openings 245 to lubricate between the planetary gears 40 and the ring gear 38.

Referring to FIG. 6, the conduit 200 provides oil through pathway C into manifold 250 in the first spray bar 41 which sprays oil through nozzles 255 on the sun gear.

Referring now to FIG. 7, oil drips (see arrows) from the planetary gears 40 and the sun gear 36 about the carrier 50 and is trapped by the forward gutter 90 and the aft gutter 95. Oil captured by the forward gutter 90 is collected through scupper 265 for transport into an auxiliary oil tank 270. Similarly, oil captured by the aft gutter 95 travels through opening 275 and opening 280 in the ring gear support 285 into the forward gutter 90 to be similarly collected by the scupper 265 to go to the auxiliary oil tank 270. Some oil passes through openings 290, 295 within the ring gear 38 and drips upon the flexible coupling 85 and migrates through holes 300 therein and drains to the main scavenge area (not shown) for the engine 10.

As is clear from FIGS. 5 and 7, there is a recess adjacent the outer periphery of the ring gear 38. The recess identified by 602, can be seen to be formed by half-recess portions in each of two separate gear portions 600 which form the ring gear 38. As is clear, the recess 602 is radially outwardly of the gear teeth 603 on the ring gear 38. This recess helps balance force transmitted through the ring gear as the various interacting gear members shift orientation relative to each other.

Referring now to the Figures, In view of these shortcomings a simple, reliable, unlubricated coupling system for connecting components of an epicyclic gear train 30 to external devices while accommodating misalignment therebetween is sought.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gas turbine engine comprising:
a fan shaft diving a fan having fan blades;
a gear system including a sun gear surrounded by a plurality of intermediate gear, a carrier at least partially supporting said plurality of intermediate gears, and a ring gear surrounding said plurality of intermediate gears, wherein said sun gear is driven by a turbine;
a flexible coupling fixing said ring gear from rotation relative to an engine static structure; and
a lubricating system for said gear system, said lubricating system including a lubricant input, there being a stationary first bearing receiving lubricant from said lubricant input, said first bearing having an inner first race in which lubricant flows, and a second bearing for rotation within said first bearing, said second bearing having a first opening in registration with said inner first race such that lubricant may flow from said inner first race through said first opening into a first conduit, wherein said first conduit is in fluid communication with said plurality of intermediate gears.

2. The gas turbine engine of claim 1, wherein said ring gear includes a recess located radially outward of gear teeth on said ring gear.

3. The gas turbine engine of claim 2, wherein said ring gear includes a radially extending fluid passage for directing lubricant from said first conduit to said flexible coupling.

4. The gas turbine engine of claim 3, wherein said ring gear comprises a first gear portion with a first set of teeth and a second gear portion with a second set of teeth, wherein said recess is configured to balance force transmitted through said ring gear and said recess comprises a first half-recess in said first gear portion and a second half-recess in said second gear portion.

5. The gas turbine engine of claim 4, further comprising a forward gutter and an aft gutter around an outer edge of said ring gear to collect lubrication used by said lubrication system.

6. The gas turbine engine of claim 5, wherein said aft gutter is spaced radially from said forward gutter.

7. The gas turbine engine of claim 6, wherein said aft gutter is in fluid communication with said forward gutter through an axially extending passage in said ring gear.

8. The gas turbine engine of claim 1, wherein said first bearing further comprises a stationary second race into which lubricant flows, and said second bearing having a second opening in registration with said second race such that lubricant flows from said second race through said second opening into a second conduit.

9. The gas turbine engine of claim 8, wherein said second conduit passes lubricant to a component of said gas turbine engine.

10. The gas turbine engine of claim 8, wherein said first conduit passes lubricant to a first part of said gas turbine engine and said second conduit passes lubricant to a second part of said gas turbine engine different from said first part of said gas turbine engine.

11. The gas turbine engine of claim 10, wherein said second conduit passes lubricant to a spray bar, wherein said spray bar is disposed on said carrier and provides lubricant to said plurality of intermediate gears and to said ring gear.

12. The gas turbine engine of claim 11, wherein said first bearing had a third inner race and said second bearing has a third opening in registration with said third inner race and a third conduit for passing lubricant through said first spray bar.

13. The gas turbine engine of claim 11, further comprising a second spray bar extending from said first spray bar.

14. The gas turbine engine of claim 13, wherein said second spray bar provides lubricant to a low spool of said gas turbine engine.

15. The gas turbine engine of claim 10, wherein said ring gear comprises a recess and a first gear portion with a first set of teeth and a second gear portion with a second set of teeth, and wherein said recess comprises a first half-recess radially outward of gear teeth in said first gear portion and a second half-recess radially outward of gear teeth in said second gear portion.

16. A gas turbine engine comprising:
a fan shaft diving a fan having fan blades;
a gear system including a sun gear surrounded by a plurality of intermediate gear, a carrier at least partially supporting said plurality of intermediate gears, and a ring gear surrounding said plurality of intermediate gears, wherein said sun gear is driven by a turbine;
a planetary gear train having at least one planetary gear, a sun gear, a ring gear fixed from rotation relative to an engine static structure, a carrier supporting said at least one planetary gear, said carrier driving said fan; and
a flexible coupling fixing said ring gear from rotation relative to an engine static structure;
lubricating system for said planetary gear train, said lubricating system including a stationary oil transfer bearing configured to receive lubrication for said lubricating system, and at least one gutter around an outer edge of said ring gear to collect lubrication used by said lubrication system; and
a low spool for driving said fan via said planetary gear train.

17. The gas turbine engine of claim 16, wherein said at least one gutter includes a forward gutter and an aft gutter located around an outer edge of said ring gear to collect lubrication used by said lubrication system.

18. The gas turbine engine of claim 17, wherein said aft gutter is spaced radially from said forward gutter.

19. The gas turbine engine of claim 18, wherein said aft gutter is in fluid communication with said forward gutter through an axially extending passage in said ring gear.

20. The gas turbine engine of claim 16, wherein said stationary oil transfer bearing is a first bearing and further comprising a second bearing projecting aft from said carrier about said low spool and said stationary oil transfer bearing is prevented from rotation by attachment to said at least one gutter.

21. The gas turbine engine of claim 20, wherein said first bearing has an inner first race in which lubricant flows, and said second bearing is configured for rotation within said first bearing, said second bearing having a first opening in registration with said inner first race such that lubricant may flow from said inner first race through said first opening into a first conduit.

22. The gas turbine engine of claim 21, wherein said stationary oil transfer bearing is attached to said at least one gutter via a link, said link attached to an oil input coupling via a tab, said oil input coupling attached to said at least one gutter.

23. The gas turbine engine of claim 22, wherein said tab includes ears extending from said tab, and said link is attached to said ears via a pin.

24. The gas turbine engine of claim 22, wherein said stationary oil transfer bearing includes a boss, said boss including a pair of ears, and wherein said link is attached to said boss via a ball and a pin extending through said ball and said pair of ears.

25. The gas turbine engine of claim 24, wherein said ball allows said oil transfer bearing to flex or torque with said low spool.

26. The gas turbine engine of claim 21, wherein said first bearing also has a stationary second race into which lubricant flows, and said second bearing having a second opening in registration with said second race such that lubricant flows from said second race through said second opening into a second conduit.

27. The gas turbine engine of claim 26, wherein said first conduit passes lubricant to a first part of said gas turbine engine, and said second conduit passes lubricant to a second part of said gas turbine engine different from said first part of said gas turbine engine.

28. The gas turbine engine of claim 27, further comprising a spray bar disposed on said carrier receiving lubricant from said second conduit and providing lubricant to said at least one planetary gear and to said ring gear.

29. The gas turbine engine of claim 28, further comprising a second spray bar extending from said first spray bar.

30. The gas turbine engine of claim 29, wherein said second spray provides lubricant to said low spool and lubricant flows from said first spray bar to said second spray bar.
